(19) United States
(12) Patent Application Publication
(10) Pub. No.: US 2026/0118516 A1
(43) Pub. Date: Apr. 30, 2026

(54) SMART SPACE VEHICLE SELECTION

(71) Applicant: QUALCOMM Incorporated, San Diego, CA (US)

(72) Inventors: David TUCK, San Juan Capistrano, CA (US); Krishnaranjan RAO, Sunnyvale, CA (US); Konduru Pranay KUMAR RAJU, Rayachoti (IN)

(21) Appl. No.: 18/929,300

(22) Filed: Oct. 28, 2024

(51) Int. Cl. G01S 19/13; H04W 48/16; H04W 72/51; H04W 72/56

(52) U.S. Cl. CPC G01S 19/13; H04W 48/16; H04W 72/51; H04W 72/56

(57) ABSTRACT

Aspects presented herein may enable a user equipment (UE) to maintain an optimized priority list of global navigation satellite system (GNSS) signals/channels to achieve a best GNSS positioning performance with limited resources in real-time. In one aspect, a UE identifies a maximum number of GNSS signals to be used by the UE for GNSS positioning. The UE prioritizes a set of available GNSS signals for the GNSS positioning based on one or more conditions. The UE selects the maximum number of GNSS signals to be used for the GNSS positioning from the prioritized set of GNSS signals. In some implementations, the UE may detect that a number of available GNSS signals exceeds the maximum number of GNSS signals to be used by the UE for the GNSS positioning, where the prioritization of the set of GNSS signals is based on the detection.

### TECHNICAL FIELD

The present disclosure relates generally to communication systems, and more particularly, to wireless communication involving positioning.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning protocols and techniques that enable mobile network operators to provide high-accuracy location services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus identifies a maximum number of global navigation satellite system (GNSS) signals to be used by the UE for GNSS positioning. The apparatus prioritizes a set of available GNSS signals for the GNSS positioning based on one or more conditions. The apparatus selects the maximum number of GNSS signals to be used for the GNSS positioning from the prioritized set of GNSS signals.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of global navigation satellite system (GNSS) positioning in accordance with various aspects of the present disclosure.

FIG. 6 is a diagram illustrating an example navigational frequency band for GNSS in accordance with various aspects of the present disclosure.

FIG. 7 is a diagram illustrating an example Bangalore cumulative distribution function (CDF) for GPS bands in accordance with various aspects of the present disclosure.

FIG. 8 is a communication flow illustrating an example procedure of enabling a UE to prioritize GNSS channels based on its capability in accordance with various aspects of the present disclosure.

FIG. 9 is a diagram illustrating an example of prioritizing/sorting/ordering a list of GNSS signals based on a plurality of rules/conditions in accordance with various aspects of the present disclosure.

FIG. 10 is a diagram illustrating an example of prioritizing/sorting/ordering a list of GNSS signals based on a plurality of rules/conditions in accordance with various aspects of the present disclosure.

FIG. 11 is a diagram illustrating an example of prioritizing/sorting/ordering a list of GNSS signals based on a plurality of rules/conditions in accordance with various aspects of the present disclosure.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

### DETAILED DESCRIPTION

Aspects presented herein may improve the overall performance of global navigation satellite system (GNSS) positioning by enabling a GNSS device to sort a list of available GNSS signals in priority and select the signals to be tracked (e.g., to be used for the positioning) based on their places in the list and the available resources of the GNSS device. For example, if a GNSS device is in an area with X GNSS signals/channels available and the GNSS device is just able to process Y GNSS signals/channels where X is greater than Y (X>Y), the GNSS device may be configured to order/sort the X GNSS signals/channels based on a set of rules (e.g., a series of conditions, which may be denoted as “1:N” for N conditions/rules), and then select Y GNSS signals/channels or allocate resources to Y GNSS signals/channels from the ordered/sorted X GNSS signals/channels. As such, aspects presented herein may enable the GNSS device to select GNSS signals/channels that are most suitable/best fit for the positioning when there are abundant GNSS signals/channels, which may provide better positioning performance compared to the (traditional) all-in-view tracking approach.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

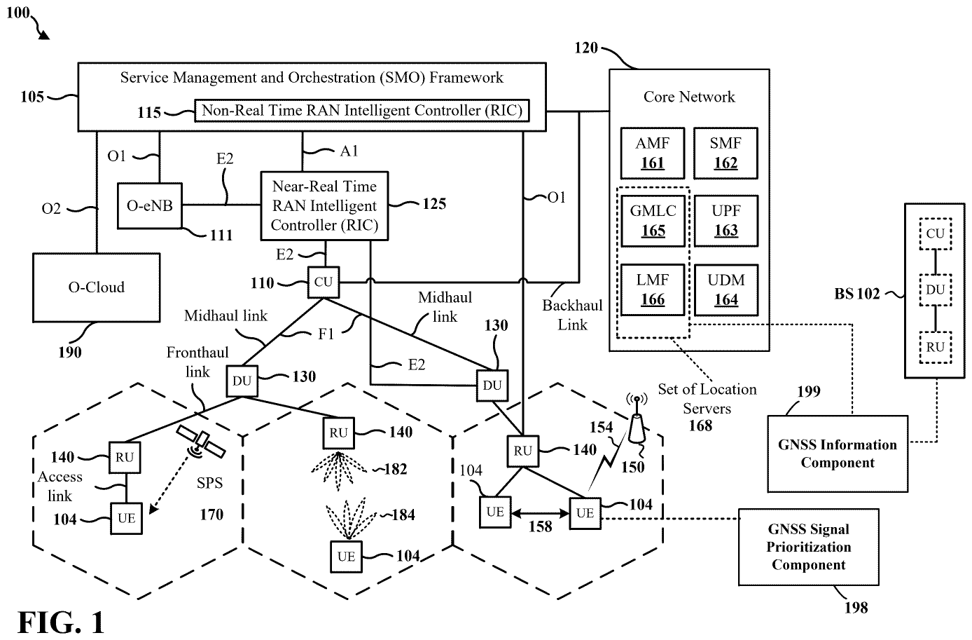

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via dataset collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smartphone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a GNSS signal prioritization component 198 that may be configured to identify a maximum number of global navigation satellite system (GNSS) signals to be used by the UE for GNSS positioning; prioritize a set of available GNSS signals for the GNSS positioning based on one or more conditions; and select the maximum number of GNSS signals to be used for the GNSS positioning from the prioritized set of GNSS signals. In certain aspects, the base station 102 and/or the one or more location servers may have a GNSS information component 199 that may be configured to provide, to the UE 104, information related to GNSS signals/channels available at the UE 104 (e.g., which may be selected based on the location of the UE 104).

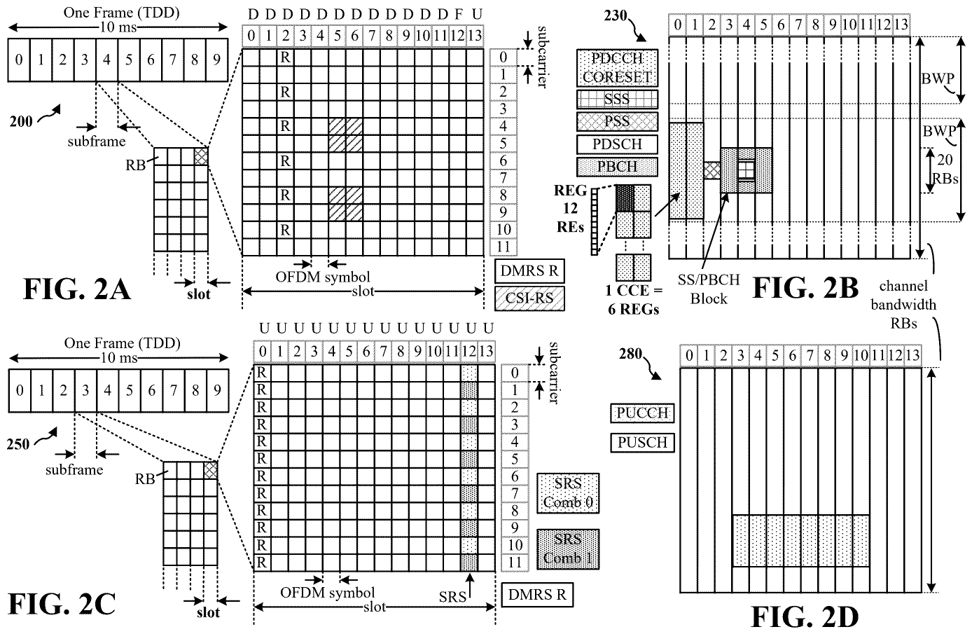

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

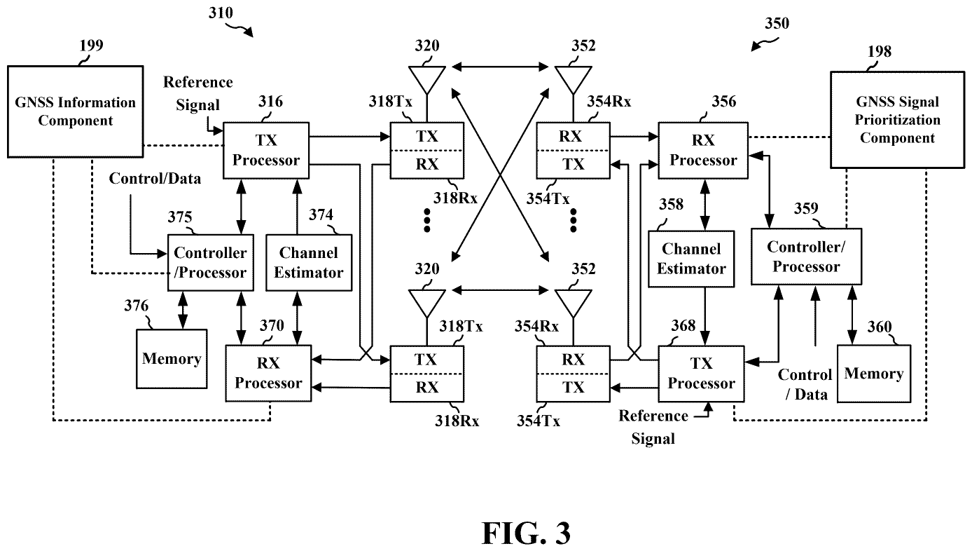

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the GNSS signal prioritization component 198 of FIG. 1.

At least one of the TX processor 316, the RX processor 370, and the controller/processor 375 may be configured to perform aspects in connection with the GNSS information component 199 of FIG. 1.

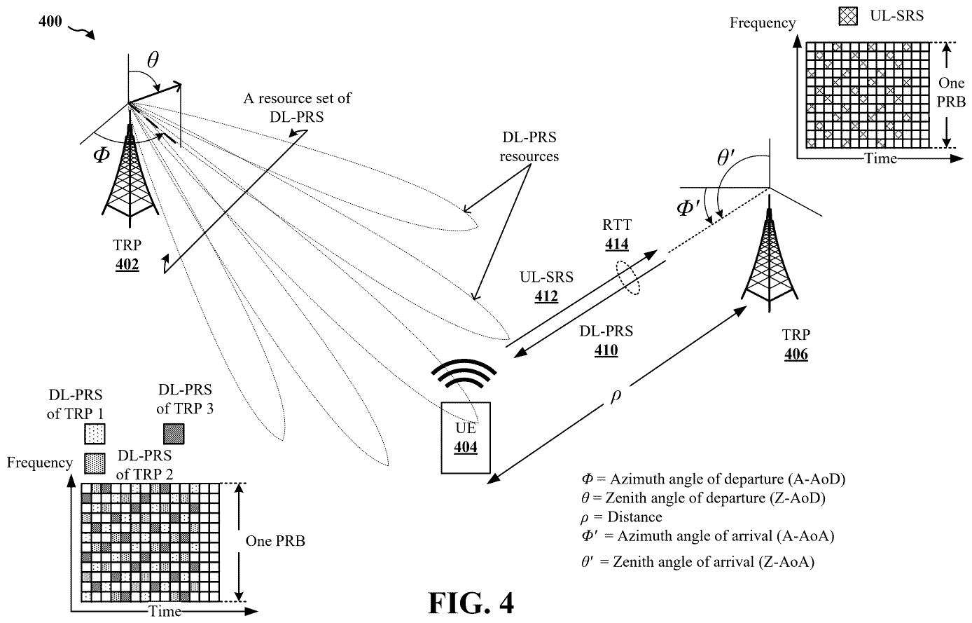

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_RX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_TX}−T_{PRS_TX}|−|T_{SRS_TX}−T_{PRS_TX}∥. Accordingly, multi-RTT positioning may make use of the UE Rx−Tx time difference measurements (i.e., |T_{SRS_TX}−T_{PRS_TX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_TX}−T_{PRS_TX}|) and UL SRS-RSRP at multiple TRPs 402, 406 of uplink signals transmitted from UE 404. The UE 404 measures the UE Rx−Tx time difference measurements (and/or DL PRS-RSRP of the received signals) using assistance data received from the positioning server, and the TRPs 402, 406 measure the gNB Rx−Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

For purposes of the present disclosure, “UE Rx−Tx time difference” may be defined as T_{UE-RX}−T_{UE-TX}, where: T_{UE-RX} is the UE received timing of downlink subframe #i from a Transmission Point (TP), defined by the first detected path in time. T_{UE-TX} is the UE transmit timing of uplink subframe #j that is closest in time to the subframe #i received from the TP. Multiple DL PRS or CSI-RS for tracking resources, as instructed by higher layers, can be used to determine the start of one subframe of the first arrival path of the TP. For frequency range 1, the reference point for T_{UE-RX} measurement may be the Rx antenna connector of the UE and the reference point for T_{UE-TX} measurement may be the Tx antenna connector of the UE. For frequency range 2, the reference point for T_{UE-RX} measurement may be the Rx antenna of the UE and the reference point for T_{UE-TX} measurement may be the Tx antenna of the UE.

“DL reference signal time difference (DL RSTD)” is the DL relative timing difference between the Transmission Point (TP) j and the reference TP i, defined as T_{SubframeRxj}−T_{SubframeRxi}, where: T_{SubframeRxj} is the time when the UE receives the start of one subframe from TP j. T_{SubframeRxi} is the time when the UE receives the corresponding start of one subframe from TP i that is closest in time to the subframe received from TP j. Multiple DL PRS resources can be used to determine the start of one subframe from a TP. For frequency range 1, the reference point for the DL RSTD may be the antenna connector of the UE. For frequency range 2, the reference point for the DL RSTD may be the antenna of the UE.

“DL PRS reference signal received power (DL PRS-RSRP),” is defined as the linear average over the power contributions (in [W]) of the resource elements that carry DL PRS reference signals configured for RSRP measurements within the considered measurement frequency bandwidth. For frequency range 1, the reference point for the DL PRS-RSRP may be the antenna connector of the UE. For frequency range 2, DL PRS-RSRP may be measured based on the combined signal from antenna elements corresponding to a given receiver branch. For frequency range 1 and 2, if receiver diversity is in use by the UE, the reported DL PRS-RSRP value may not be lower than the corresponding DL PRS-RSRP of any of the individual receiver branches.

“DL PRS reference signal received path power (DL PRS-RSRPP),” is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP may be the antenna connector of the UE. For frequency range 2, DL PRS-RSRPP may be measured based on the combined signal from antenna elements corresponding to a given receiver branch. For frequency range 1 and 2, if receiver diversity is in use by the UE for DL PRS-RSRPP measurements, the reported DL PRS-RSRPP value included in the higher layer parameter NR-DL-AoD-MeasElement for the first and additional measurements may be provided for the same receiver branch(es) as applied for DL PRS-RSRP measurements

“DL reference signal carrier phase (RSCP)” is defined as the phase of the channel response at the 1^{st} path delay derived from the resource elements carrying DL PRS configured for the measurement. DL RSCP is associated with the center frequency of the DL positioning frequency layer (PFL) configured for the measurement for RRC connected, RRC inactive, and RRC idle modes. For frequency range 1, the reference point for the DL RSCP may be the antenna connector of the UE. For frequency range 2, the reference point for the DL RSCP may be the antenna of the UE.

“DL reference signal carrier phase difference (RSCPD)” is defined as the difference of DL RSCPs measured from DL PRS transmitted in a DL PFL from the transmission point (TP) j and the reference TP i. If UE reports RSCPD measurements together with RSTD measurements in a measurement report element, the reference TP for RSCPD is the same as the reference TP reported for RSTD. For frequency range 1, the reference point for the DL RSCPD may be the antenna connector of the UE. For frequency range 2, the reference point for the DL RSCPD may be the antenna of the UE.

A device (e.g., a UE such as a smartphone, a vehicle, a navigation device, etc.) equipped with a global navigation satellite system (GNSS) receiver may determine its location based on reception of signals from multiple satellites, which may be referred to as “GNSS positioning,” “GNSS-based positioning” or “satellite-based positioning,” etc. The GNSS includes a network of satellites broadcasting timing and orbital information used for navigation and positioning measurements. In addition, GNSS may refer to the International Multi-Constellation Satellite System, which may include global positioning system (GPS), global navigation satellite system (GLONASS), BeiDou Navigation Satellite System (BDS), Galileo system, and any other constellation system(s). The GNSS may include multiple groups of satellites (which may be referred to as GNSS satellites), known as constellations, that broadcast signals (which may be referred to as GNSS signals) to control stations and users of the GNSS. Based on the broadcast signals, users may be able to determine their locations (e.g., via a trilateration process). For purposes of the present disclosure, a device (e.g., a UE) that is equipped with a GNSS receiver or is capable of receiving GNSS signals may be referred to as a GNSS device, and a device that is capable of transmitting GNSS signals, such as a satellite, may be referred to as a space vehicle (SV). As such, the term “satellite” may be used interchangeably with the term “space vehicle.” In addition, a “GNSS channel” may refer to a channel that is used for transmitting/communicating a GNSS signal, and depending on the context, the term “GNSS channel” may be used interchangeably with the term “GNSS signal.” For example, a GNSS device receiving a GNSS signal from an SV may also be described as a GNSS device communicating with an SV via a GNSS channel.

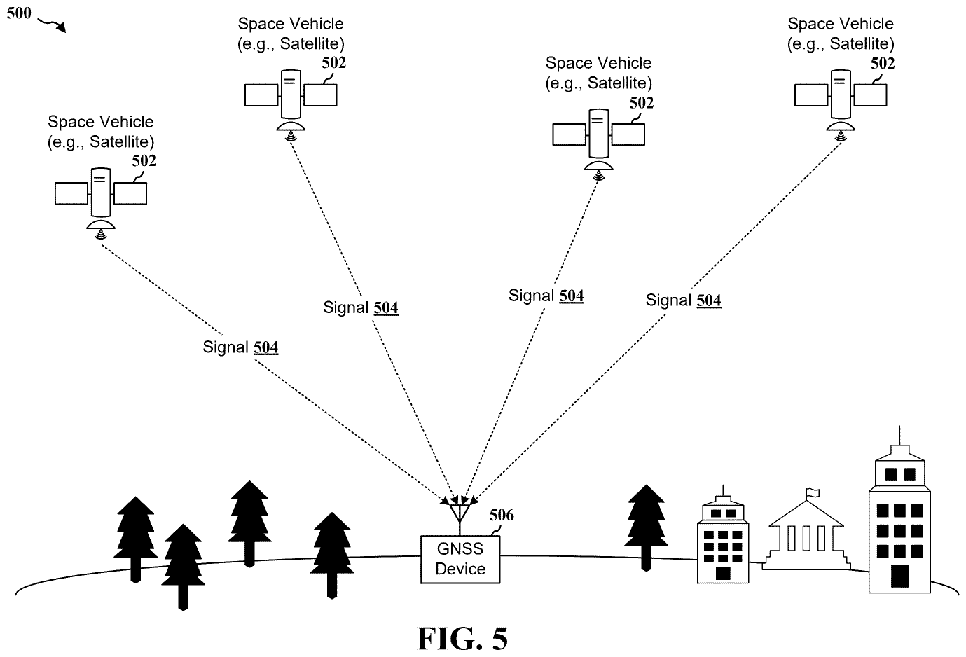

FIG. 5 is a diagram 500 illustrating an example of GNSS positioning in accordance with various aspects of the present disclosure. A GNSS device 506 may calculate its position and time based at least in part on GNSS signals 504 received from multiple SVs 502, where each of the multiple SVs 502 may carry a record of its position and time, and may transmit that record to the GNSS device 506 via the GNSS signals 504. Each of the multiple SVs 502 may further include a clock that is synchronized with other clocks of SVs and with ground clock(s). If an SV detects that there is a drift from the time maintained on the ground, the SV may correct it. The GNSS device 506 may also include a clock, but the clock for the GNSS device 506 may be less stable and precise compared to the clocks of an SV.

As the speed of radio waves may be constant and independent of the SV speed, a time delay between a time an SV transmits a GNSS signal and a time the GNSS device 506 receives the GNSS signal may be proportional to the distance from the SV to the GNSS device 506. In some examples, a minimum of four SVs may be specified to be used by the GNSS device 506 to compute/estimate one or more unknown quantities associated with positioning (e.g., three position coordinates and a clock deviation from satellite time, etc.).

An SV may be configured to broadcast the GNSS signal (e.g., a carrier wave with modulation) continuously which may include a pseudorandom code (e.g., a sequence of ones and zeros) that may be known to the GNSS device 506, and may also include a message that includes a time of transmission and the position of the SV at that time. In other words, each GNSS signal may carry two types of information: time and carrier wave (e.g., a modulated waveform with an input signal to be electromagnetically transmitted). As such, based on the GNSS signals 504 received from each of the SVs 502, the GNSS device 506 may measure the time of arrivals (ToAs) of the GNSS signals 504 and calculate the time of flights (ToFs) for the GNSS signals 504. Then, based on the calculated ToFs, the GNSS device 506 may compute its three-dimensional position and the clock deviation, and the GNSS device 506 may determine/estimate its position on the Earth. For example, the GNSS device 506's location may be converted to a latitude, a longitude, and a height/elevation relative to an ellipsoidal Earth model. These coordinates may be displayed, such as on a moving map display, or recorded or used by some other system, such as a vehicle guidance system.

While the distance between a GNSS device and an SV may be calculated based on the time it takes for a GNSS signal to reach the GNSS device, the SV's signal sequence may be delayed in relation to the GNSS device's sequence. Thus, in some examples, a delay may be applied to the GNSS device's sequence, such that the two sequences are aligned. For example, to calculate the delay, a GNSS device may align a pseudorandom binary sequence contained in the SV's signal to an internally generated pseudorandom binary sequence. As the SV's GNSS signal takes time to reach the GNSS device, the SV's sequence may be delayed in relation to the GNSS device's sequence. By increasingly delaying the GNSS device's sequence, the two sequences may eventually be aligned.

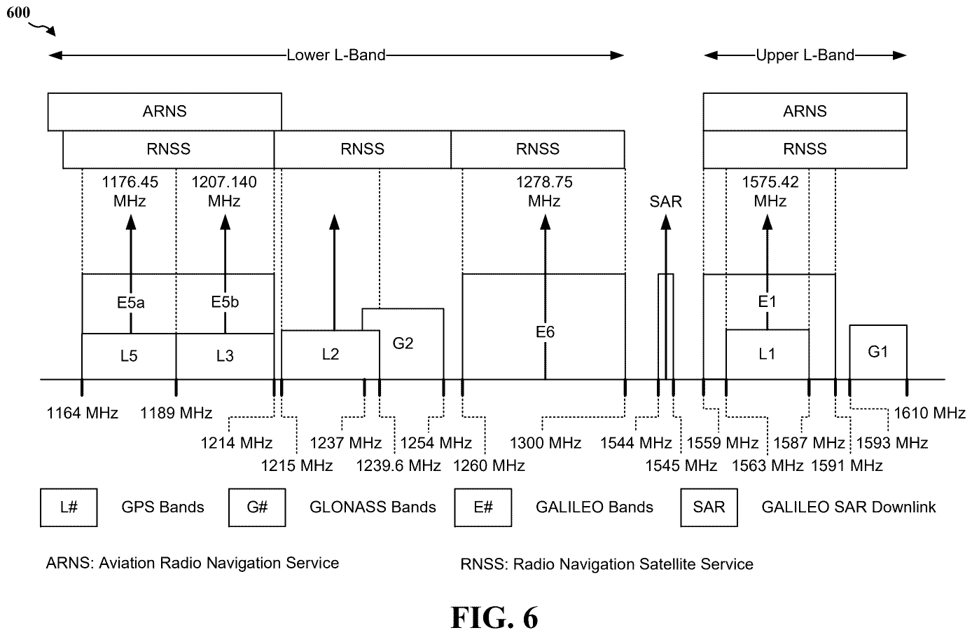

FIG. 6 is a diagram 600 illustrating an example navigational frequency band for GNSS (e.g., global positioning system (GPS), globalnaya navigatsionnaya sputnikovaya sistema (GLONASS), and Galileo (GAL) system, which may also be referred to as Radio Navigation Satellite System (RNSS)) in accordance with various aspects of the present disclosure. There may be two bands in the region allocated to the Aeronautical Radio Navigation Service (ARNS) on a primary basis worldwide, where these bands may be suitable for Safety-of-Life applications as other users may not be allowed to interfere with their signals. They may correspond to an upper L-band (e.g., 1559-1610 MHz), having the GPS L1, Galileo E1 and GLONASS G1, and to the bottom of a lower L-band (e.g., 1151-1214 MHz) where GPS L5 and Galileo E5 are located, with E5a and L5 coexisting in the same frequencies. The remaining GPS L2, GLONASS G2 and Galileo E6 signals are in the bands 1215.6-1350 MHz. These bands may be allocated to radio-location services (e.g., ground radars) and RNSS on a primary basis, hence the signals in these bands may be more vulnerable to interference compared to the previous ones.

In some examples, a software or an application that accepts positioning related measurements from GNSS/GPS chipsets and/or sensors to estimate position, velocity, and/or altitude of a device may be referred to as a positioning engine (PE). In addition, a positioning engine that is capable of achieving certain high level of accuracy (e.g., centimeter/decimeter level accuracy) and/or latency may be referred to as a precise positioning engine (PPE). On the other hand, a navigation application may refer to an application in a user equipment (e.g., a smartphone, an in-vehicle navigation system, a GPS device, etc.) that is capable of providing navigational directions in real time.

In the context of GNSS positioning, a “satellite constellation” or a “constellation” may refer to a group of satellites/SVs working together as a system. For example, a group of satellites working together for the GPS may be refer to as a constellation for GPS or a GPS constellation. Unlike a single satellite, a constellation may be capable of providing a permanent global or near-global coverage, such that at any time everywhere on Earth at least one satellite may be visible.

Traditionally, most GNSS devices may be configured to use multi-constellation (e.g., using more than one constellation) and/or multi-frequency (e.g., using more than one band) to perform GNSS positioning. That is, the GNSS devices may be configured to utilize all SVs in its view (e.g., SVs that are in line-of-sight (LOS) with the GNSS device and/or SVs with signals that can be received by the GNSS device, etc.) for the GNSS positioning, which may be referred to as the “all-in-view approach” or “all-in-view tracking approach.” For example, currently, there may be four constellations that are capable of providing a worldwide coverage: GPS, BDS, Galileo, and GLONASS. As such, a GNSS device may be configured to use all available SVs (and their available frequency bands) in its view for the GNSS positioning, where the available SVs may include one or more SVs from each of GPS, BDS, Galileo, and GLONASS.

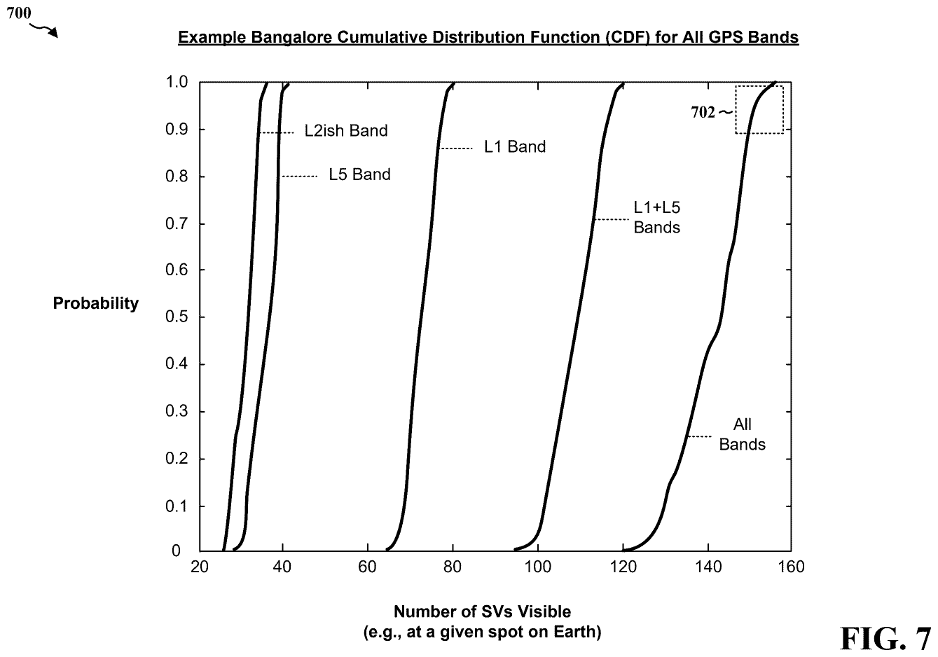

FIG. 7 is a diagram 700 illustrating an example Bangalore cumulative distribution function (CDF) for GPS bands in accordance with various aspects of the present disclosure. Over the last decade, constellations have been adding many signals, and some not defined for civilian space. Thus, more GNSS constellations have become operational and full, which result in far more broadcast signals being available between the GNSS (e.g., GPS, GLO, GAL, and BDS, etc.) and some regional or augmenting signals (e.g., Navigation with Indian Constellation (Navic) signals, and Satellite Based Augmentation System (SBAS) signals, etc.). For example, as shown at 702, in some geographical locations, a GNSS device may be able to detect more than 150 GNSS/GPS signals (e.g., >150 GNSS/GPS signals are available/visible to the GNSS device). Table 2 below shows an example list of commonly used tri-band GNSS signals.

TABLE 2
Example list of commonly used tri-band GNSS signals

| Constellation | Bands |
|---|---|
| GPS | L1, L2c, L5 |
| GAL | E1, E5a, E5b |
| GLO | G1 |
| BDS | B1i, B1c, B2a, B2b |
| Navic | N5 |
| QZSS | L1, L2c, L5 |
| SBAS | L1 |

Most GNSS devices may have the capability to support dual-band GNSS, while some (higher-end) GNSS devices may support tri-band GNSS and some (lower-end) GNSS devices may support just single-band GNSS. Note that not all satellites broadcast the newest signals as systems are updated.

While the traditional all-in-view approach of configuring a GNSS device to utilize all SVs in its view for the GNSS positioning has achieved a great positioning performance, such approach may start to face a diminishing returns issue, where continuously adding more SVs/signals to the positioning may have less and less of an impact (e.g., with regards to the performance of the positioning), and may even hurt the positioning in some instances. For example, with so many (unique) SV signals available, a GNSS device may demand significant resources just to track, form observations, and/or decode messages, etc., for all the SV signals. In addition, nowadays, GNSS devices/software/products may be configured to run with different levels of priority and resources. For example, a GNSS product/software (e.g., a GNSS mobile application) may be ported to a device that is running at a slower clock and/or with less memory/processing capacities, etc., (e.g., a lower tier UE such as a smartwatch) or to a device that is specified to share resources with other functions/radio access technologies (RATs) (e.g., a device may be demanded to lower throughput\memory as needed for 5G concurrency). As such, GNSS devices with a slower clock and/or less memory/processing capacities may support a lower number of simultaneous GNSS tracked channels. In most demanding 5G modes, these GNSS devices may also be configured to drop a significant amount of GNSS signals that are unable to be processed by them, which may negatively impact the performance of the GNSS positioning. For example, a GNSS device may have the capability to track just thirty (30) GNSS signals simultaneously. If the GNSS device is in a location with more than thirty GNSS signals available (e.g., more than one hundred (100) GNSS signals available), after the GNSS device tracks thirty GNSS signals, the GNSS device may be specified to drop other available GNSS signals. This may not be an optimal positioning configuration for the GNSS device as some of the GNSS signals tracked by the GNSS device may not be suitable for the positioning (e.g., has a low elevation, weak signal, different error profiles, satellite state accuracies, and/or specified states, etc.) compared to other GNSS signals that are dropped by the GNSS device.

Aspects presented herein may improve the overall performance of GNSS positioning by enabling a GNSS device to sort a list of available GNSS signals in priority and select the signals to be tracked (e.g., to be used for the positioning) based on their places in the list and the available resources of the GNSS device. For example, if a GNSS device is in an area with X GNSS signals/channels available and the GNSS device is just able to process Y GNSS signals/channels where X is greater than Y (X>Y), the GNSS device may be configured to order/sort the X GNSS signals/channels based on a set of rules (e.g., a series of conditions, which may be denoted as “1:N” for N conditions/rules), and then select Y GNSS signals/channels or allocate resources to Y GNSS signals/channels from the ordered/sorted X GNSS signals/channels. As such, aspects presented herein may enable the GNSS device to select GNSS signals/channels that are most suitable/best fit for the positioning when there are abundant GNSS signals/channels, which may provide better positioning performance compared to the (traditional) all-in-view tracking approach or at least an optimal solution given the resources available.

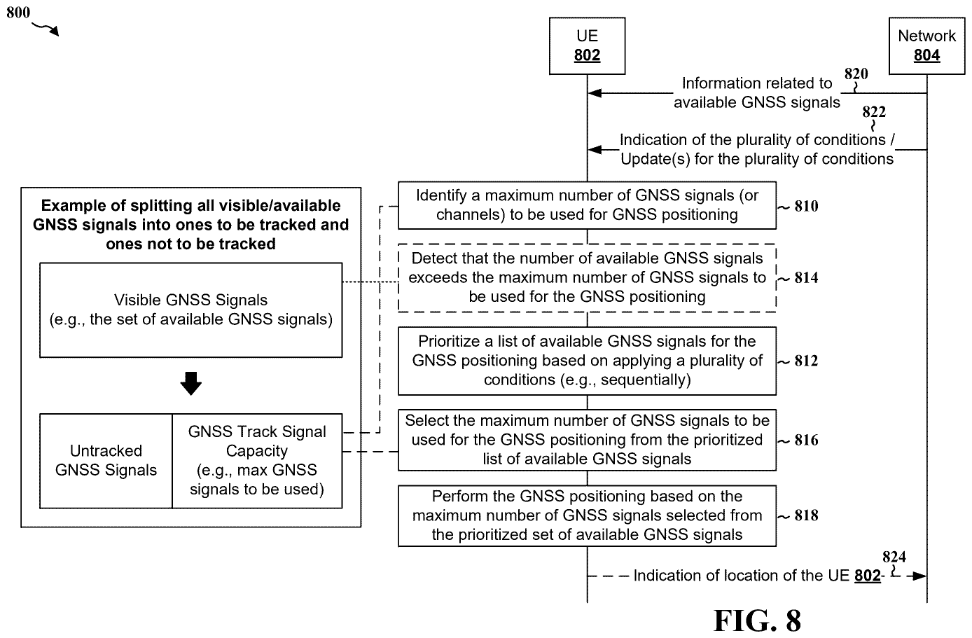

FIG. 8 is a communication flow 800 illustrating an example procedure of enabling a UE to prioritize GNSS channels based on its capability in accordance with various aspects of the present disclosure. The numberings associated with the communication flow 800 do not specify a particular temporal order and are merely used as references for the communication flow 800. Aspects presented herein may enable a UE to optimize GNSS track channels based on higher order rules degrading performance gracefully.

At 810, a UE 802 (e.g., a GNSS device, a device with a GNSS receiver, etc.) may be configured to identify a maximum (max) number of GNSS signals (or GNSS channels) that is to be used by the UE 802 for GNSS positioning (or for a GNSS positioning session). For purposes of the present disclosure, a GNSS solution may refer to the calculated position, velocity, and time (PVT) of an object using signals from GNSS. The position may be the latitude, longitude, and altitude of the GNSS receiver (e.g., the UE 802), the velocity may be the speed and direction of the receiver's movement, and the time may be the accurate timing information (e.g., typically down to nanoseconds). Note that an SV/satellite may broadcast more than one type/band of GNSS signal/channel. Depending on implementations, the UE 802 may determine the maximum number of GNSS signals based on a defined/pre-defined algorithm, and/or based on its (current) capability/capacity.

For example, in one aspect of the present disclosure, the UE 802 may be configured to identify the maximum number of GNSS signals to be used for the GNSS positioning based on (1) whether the UE 802 is used solely for the GNSS positioning (e.g., the UE 802 is designed to perform just the GNSS positioning, such as a tracking device on a cargo, or the UE 802 is just running the GNSS positioning task), (2) at least one type of radio access technology (RAT) (e.g., 4G LTE, 5G NR, Bluetooth®, Wi-Fi®, UWB, etc.) used by the UE simultaneously with the GNSS positioning, (3) a location of the UE, (4) an environmental condition of the UE, and/or (5) a capability of the UE, etc. As an illustration, if the UE 802 is used solely for the GNSS positioning purposes, the UE 802 may be configured to track a maximum of one hundred (100) GNSS signals. On the other hand, if the UE 802 is configured to perform both GNSS positioning and a wireless communication (e.g., using at least one RAT for wireless communication such as described in connection with FIG. 1), the UE 802 may be configured to track with a lesser number of GNSS signals (compared to the UE 802 that is used solely for the GNSS positioning). For example, the UE 802 may be configured to track a maximum of fifty (50) GNSS signals if it is performing 5G NR communication simultaneously/concurrently with the GNSS positioning, or track a maximum of seventy-five (75) GNSS signals if it is performing 4G LTE communication simultaneously/concurrently with the GNSS positioning, etc. In another example, if the UE 802 is under an open sky area, the UE 802 may be configured to track a lower maximum number of GNSS signals compared to if the UE 802 is in an urban area (e.g., with tall buildings). In another example, if the UE 802 is a wireless device with higher capabilities (e.g., a smartphone), the UE 802 may be configured to track a higher maximum number of GNSS signals compared to if the UE 802 is a wireless device with lower combabilities (e.g., a smartwatch, an IoT device, etc.).

In another aspect of the present disclosure, the UE 802 may be configured to identify the maximum number of GNSS signals to be used for the GNSS positioning based on one or more parameters related to its (current) status. For example, to identify the maximum number of GNSS signals to be used for the GNSS positioning, the UE 802 may first determine the (maximum) number of resources that can be used by the UE 802 for processing GNSS signals. Then, the UE 802 may choose/identify the maximum number of GNSS signals be used for the GNSS positioning based on the determined (maximum) number of resources that can be used for processing GNSS signals. Depending on implementations, the (maximum) number of resources that can be used for processing GNSS signals may be determined/calculated based on: (1) a current maximum number of resources that can be allocated for the GNSS positioning, (2) a current processing capability or capacity of the UE 802, (3) a current memory capability or capacity of the UE 802, (4) a current or a desired throughput of the UE 802, (5) a current or a desired central processing unit (CPU) load of the UE 802, and/or (6) a current temperature of one or more components of the UE 802, etc.

For example, if the UE 802 is (currently) configured to run one or more other applications (e.g., a vehicle UE that is performing GNSS positioning and also object detections, assisted/autonomous driving, etc.), the UE 802 may be specified/restricted to use just an X % (e.g., 50%, 60%, etc.) of total resources available for processing the GNSS signals (or for GNSS positioning). In another example, the UE 802 may be specified/restricted to use just currently available processing capacity and/or memory capability for the GNSS processing the GNSS signals (or for GNSS positioning). In other words, the (maximum) number of resources that can be used for processing GNSS signals (or the maximum number of GNSS signals to be used for the positioning) may be changing dynamically based on the current processing/memory capacity of the UE 802. In another example, if the UE 802 detects that the temperature of its CPU(s) exceeds a temperature threshold or the UE 802 is specified to achieve a specified throughput, the UE 802 may be configured to use a lower maximum number of resources for processing GNSS signals.

At 812, the UE 802 may obtain a list of GNSS signals available to the UE 802, and the UE 802 may prioritize this list of available GNSS signals for the GNSS positioning based on applying a plurality of rules/conditions. In some examples, the UE 802 may be configured to applying the plurality of rules/conditions sequentially. Depending on implementations, the list of GNSS signals available to the UE 802 may be pre-configured for the UE 802, detected by the UE 802, and/or received from a network entity 804 (e.g., a positioning server, a location management function (LMF), a cloud server, a base station/TRP, etc.) such as shown at 820 (e.g., which may be based on an estimated location/geographical area of the UE 802). As discussed in connection with FIG. 6, the list of available GNSS signals includes one or more of: a set of Global Positioning System (GPS) signals, a set of BeiDou navigation satellite system (BDS) signals, a set of Galileo System (GAL) signals, a set of Globalnaya Navigatsionnaya Sputnikovaya Sistema (GLONASS) signals, a set of Navigation with Indian Constellation (NavIC) signals, and/or a set of Satellite Based Augmentation System (SBAS) signals, etc.

In some implementations, as shown at 814, the UE 802 may also be configured to detect whether the number of available GNSS signals exceeds the maximum number of GNSS signals that is to be used by the UE 802 for the GNSS positioning (e.g., identified/determined at 810). Then, the UE 802 may perform the prioritization of the list of GNSS signals (or the available GNSS signals) if the number of available GNSS signals exceeds the maximum number of GNSS signals to be used for the GNSS positioning. On the other hand, if the number of available GNSS signals does not exceed the maximum number of GNSS signals to be used for the GNSS positioning, the UE 802 may skip the prioritization step. For example, if there are 150 available GNSS signals and the UE 802 is configured to use a maximum of 100 GNSS signals for the GNSS positioning, the UE 802 may initiate the prioritization of the 150 available GNSS signals based on a set of rules/conditions (discussed below). However, if there are just 60 available GNSS signals and the UE 802 is configured to use a maximum of 100 GNSS signals for the GNSS positioning, then the UE 802 may skip the prioritization process and use the 60 available GNSS signals for the GNSS positioning. In other words, the algorithm discussed in connection with FIG. 8 may be triggered based on the number of available GNSS signals being higher than the maximum amount of GNSS signals that can be processed by the UE 802.

Referring back to 812, to prioritize the list of available GNSS signals, the UE 802 may be configured to apply a plurality of (defined/pre-configured) rules/conditions to the list of available GNSS signals (sequentially). For examples, the UE 802 may be configured to apply N rules/conditions sequentially (1:N) (e.g., applying rule 1, then rule 2, then rule 3, and up to rule N), which may be defined in advance and implemented on resource constraint conditions. In one implementation, the plurality of rules/conditions may include prioritizing/ordering the list of available GNSS signals based on (1) visibilities or signal strengths of the list of available GNSS signals, (2) elevation angles of the list of available GNSS signals, (3) types of the list of available GNSS signals, and/or (4) a set of geographical inputs related to the UE 802.

Geographical inputs may refer to environmental information related the UE 802. For example, three-dimensional (3D) maps may provide blockage information, detail, or predictions on routes due to crowd sourcing (historical or recent) sharing between users (e.g., from vehicles driving on the road and actively tracking signals). In some scenarios, when a UE removes one satellite from positioning, there may be a signification change in the dilution of precision (DOP). For example, assuming “A” represents a design matric (n rows×3) (e.g., A=design matric (n rows×3)), the i^{th} row may be the partial derivative of the range with regards to a position (x, y, z) to a satellite. The range may be calculated based on:

$$range = \sqrt{( {( {x}_{S V i} - x )}^{2} + {( {y}_{S V i} - y )}^{2} + {( {z}_{S V i} - z )}^{2} )}$$

The i^{th} row may also be known as an LOS vector in (x, y, z), where a cofactor matrix Qₓ=(A^{T}A)⁻¹ and position DOP (PDOP)=\sqrt{Trace(Qₓ)}. In some examples, this may also be represented as (H^{T} H)⁻¹ instead (e.g., the DOP comes from the trace of (H^{T} H)⁻¹). Iteratively, if removing an unprioritized satellite is able to result/cause the PDOP to be significantly greater than a last used satellite, this satellite may be prioritized over the last satellite on the list.

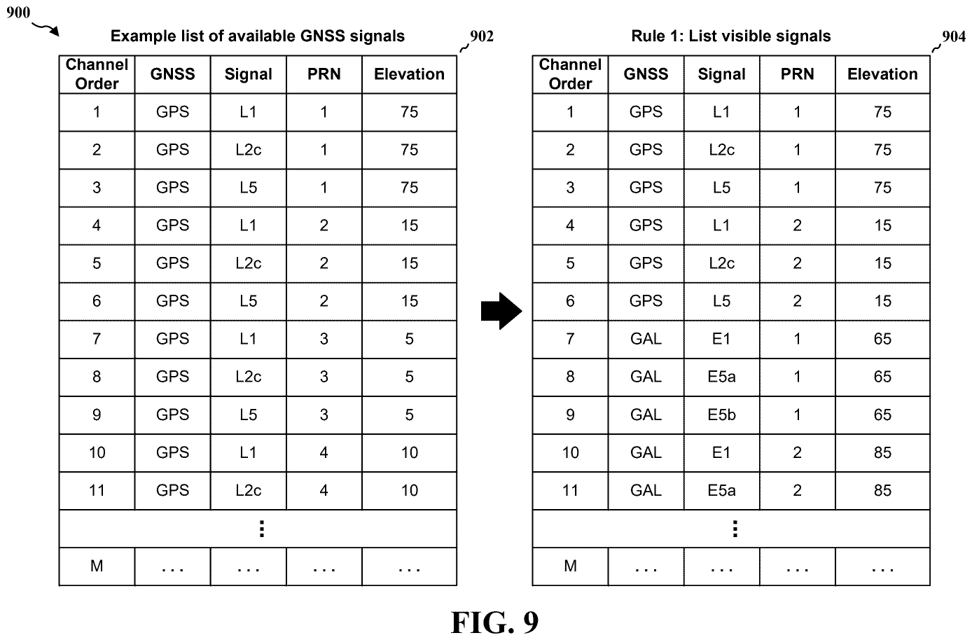

FIGS. 9, 10, and 11 are diagrams 900, 1000, and 1100, respectively, illustrating an example of prioritizing/sorting/ordering a list of GNSS signals based on a plurality of rules/conditions in accordance with various aspects of the present disclosure. As shown at 902 of FIG. 9, the UE 802 may initially have a list of available GNSS signals which the UE 802 may use for the GNSS positioning. As discussed above, the list of available GNSS signals may be (pre-)configured for the UE 802 and/or obtained/received from a server (e.g., from the network entity 804 based on an estimated location of the UE 802) or another wireless device, etc. As an illustration, the list of available GNSS signals may include 62 GPS signals, 60 GAL signals, and 30 BDS signals, etc. (e.g., a total of M available GNSS signals).

At shown at 904, the UE 802 may be configured to apply a first rule/condition in the plurality of rules/conditions to the list of available GNSS signals, where the first rule/condition may configure the UE 802 to prioritize/order the list of available GNSS signals based on the visibilities/signal strength of the GNSS signals. For example, the UE 802 may prioritize/order the list of available GNSS signals based on their visibility (e.g., the GNSS signals being line-of-sight (LOS) with the UE 802) and/or based on their received signal strength being above a defined signal strength threshold. As such, GNSS signals that are in LOS with the UE 802 and/or with the received signal strength above the defined signal strength threshold may be moved to the top of the list, and GNSS signals that are not in LOS with the UE 802 and/or with the received signal strength below the defined signal strength threshold may be moved to the bottom of the list. For example, if there are a total of 150 GNSS signals, the top 100 GNSS signals may be GNSS signals that are in LOS with the UE 802 and/or with the received signal strength above the defined signal strength threshold, and the bottom 50 GNSS signals may be GNSS signals that are not in LOS with the UE 802 and/or with the received signal strength below the defined signal strength threshold.

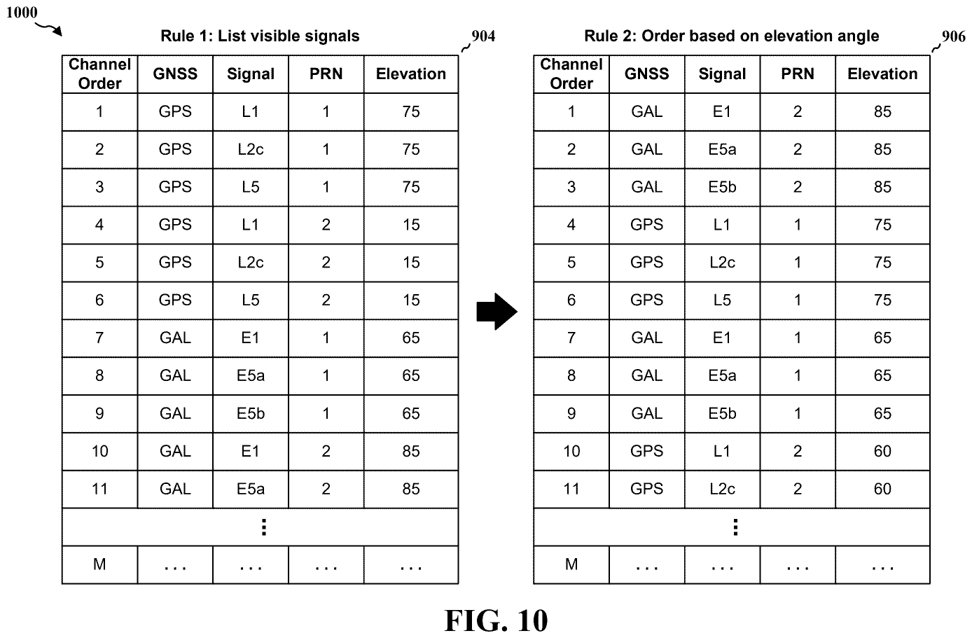

As shown at 906 of FIG. 10, after apply the first rule/condition, the UE 802 may apply a second rule/condition in the plurality of rules/conditions to the resulting list of available GNSS signals (e.g., to the list of available GNSS signals shown at 904), where the second rule/condition may configure the UE 802 to prioritize/order the resulting list of available GNSS signals based on their elevation angles (with respect to the UE 802). For example, the UE 802 may move GNSS signals with higher elevation angles or with elevation angles above an elevation threshold (and also with LOS conditions and/or received signal strength above the defined signal strength threshold as applied by the first rule/condition) above the GNSS signals with lower elevation angles or with elevation angles below the elevation threshold (and also with LOS conditions and/or received signal strength above the defined signal strength threshold as applied by the first rule/condition). Similarly, for GNSS signals without LOS conditions and/or with received signal strength below the defined signal strength threshold as applied by the first rule/condition, the UE 802 may also order them based on their elevation angles.

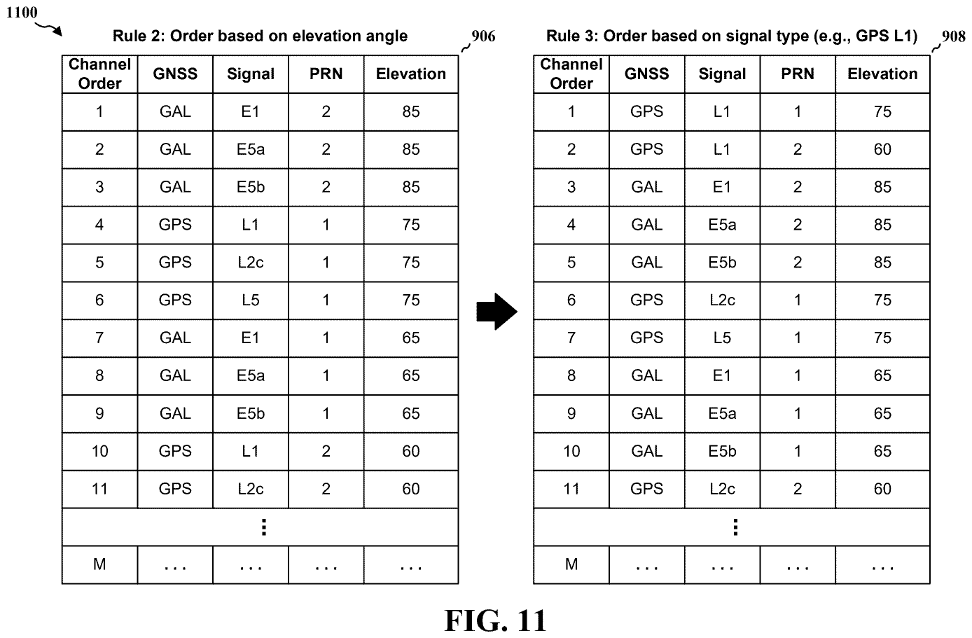

As shown at 908 of FIG. 11, after apply the second rule/condition, the UE 802 may apply a third rule/condition in the plurality of rules/conditions to the resulting list of available GNSS signals (e.g., to the list of available GNSS signals shown at 906), where the third rule/condition may configure the UE 802 to prioritize/order the resulting list of available GNSS signals based on signal type. For example, the UE 802 may be configured to prioritize the GPS L1 signals, where GPS L1 signals (and also with LOS conditions and/or received signal strength above the defined signal strength threshold as applied by the first rule/condition and with elevation angles above the elevation threshold as applied by the second rule/condition) may be moved above the non-GPS L1 signals (and also with LOS conditions and/or received signal strength above the defined signal strength threshold as applied by the first rule/condition and with elevation angles above the elevation threshold as applied by the second rule/condition). In other words, the UE 802 may apply the first, second, and third rules/conditions sequentially to the initial list of available GNSS signals, where GNSS signals that satisfy all three rules/conditions are likely to be at the top of the list, and GNSS signals that do not satisfy any of the three rules/conditions are likely to be at the bottom of the list. For purposes of the present disclosure, the list of available GNSS signals that has been prioritized/ordered with the plurality of rules/conditions may be referred to as the “prioritized list of available GNSS signals” or “prioritized list of GNSS signals.” Note the example shown on FIGS. 9 to 11 are merely for illustration purposes, and is not intended to limit the scope of the present disclosure. There may be a variety of ways to order the list of GNSS signals which may be deemed to be within the scope of the present disclosure.

In another example, the UE 802 may also be configured to (further) order the list of available GNSS signals (e.g., the list shown at 908) based on a set of priori variances, a set of observations related to expected position error, a set of geographic selections, and/or a radio frequency (RF) band grouping, etc.

In some examples, the UE 802 may also be configured to (further) order the list of available GNSS signals (e.g., the list shown at 908) based on a constellation precedence, or a policy associated with a country, a region, or a geographical area in which the UE 802 is located. In recent years, as each constellation (e.g., each satellite system such as GPS, BDS, Galileo, or GLONASS, etc.) continues to grow and expands its SVs, there may be sufficient SVs in a constellation for a GNSS device to perform GNSS positioning (e.g., at any given point on the Earth) using just SVs in that constellation. In addition, due to efficiency and/or regulations, some manufacturers and/or countries may desire to promote a specific constellation, and apply restriction(s) to other constellation(s). For example, a manufacture may promote the use of just one constellation as SVs in the same constellation may be better synchronized with each other, thereby improving the efficiency of the GNSS positioning (e.g., there may also be less frequency/band switching for the GNSS device compared to the use of multiple constellations, which may improve the power consumption at the GNSS device). In another example, a country may request/specify at least users within the country to use the constellation it developed. In some examples, the request/regulation/promotion of using one constellation over other constellation(s) may be referred to as a “precedence,” “constellation precedence,” and/or a “specific constellation precedence.” For example, a country that requests users to specifically use a GPS constellation or a BDS constellation may be referred to as a country that requests/applies a GPS precedence or a BDS precedence, respectively.

Referring back to FIG. 8, in some implementations, as shown at 822, the UE 802 may receive the plurality of rules/conditions, or update(s) to the plurality of rules/conditions, from the network entity 804 from time to time (or periodically), such that the way UE 802 prioritizes the available GNSS signals may be modified or changed (dynamically).

At 816, after prioritizing the list of available GNSS signals based on applying the plurality of rules/conditions sequentially, the UE 802 may select the maximum number of GNSS signals to be used for the GNSS positioning from the prioritized list of available GNSS signals. For example, if the UE 802 is configured to use a maximum of 75 GNSS signals for the GNSS positioning, the UE 802 may be configured to use the top 75 GNSS signals from the prioritized list of available GNSS signals shown at 908 of FIG. 11.

At 818, the UE 802 may perform the GNSS positioning based on the maximum number of GNSS signals selected from the prioritized set of available GNSS signals (e.g., based on using the 75 GNSS signals selected from the prioritized list of available GNSS signals shown at 908 of FIG. 11), such as measuring these GNSS signals. For example, to perform the GNSS positioning, the UE 802 may estimate the location of the UE 802 based on measurements of the GNSS signals, and output an indication of the location of the UE 802, such as transmit the location of the UE 802 as shown at 824, store the location of the UE 802 (e.g., at a non-volatile memory), and/or display, via a user interface (UI), the location of the UE 802, etc.

Aspects presented herein may enabling a UE to apply a set of rules/conditions to make an ordered list of signal types updated periodically. While changing/updating GNSS channels for positioning as fast as possible may be desired in some scenarios, frequent GNSS channel changing/updating may make the GNSS positioning inefficient due to reacquisition, pull-in, geometry shifts result in systematic offsets applied to positioning filters. Thus, Aspects presented herein may also allow the UE to allocate resources for GNSS positioning dynamically, where the UE may update the maximum resources for the GNSS positioning as its status changes (e.g., the modem switches to a more CPU\memory intensive state). The prioritized/ordered list of GNSS signals also enable lowest priority channels to be dropped, thereby enabling the UE to maintain an optimal performance with given resources.

Aspects presented herein may also improve the resource usage at a UE by enabling the UE to maintain an optimized priority list to achieve a best navigation performance with limited resources in real-time. Since UE resources may be shared and are limited, and the increasing number of visible GNSS signals have appear to diminish returns of improvement to performance, aspects presented herein may reduce resource usage compared to the all-in-view tracking approach while also maintaining the desired GNSS positioning performance. In addition, for wireless communications such as 5G WWAN concurrency and C-V2X, etc., high update rate specifications (e.g., auto minimum 10 Hz) are operating modes that may put stress on CPU throughput and resources. Thus, mode switches like this may result in a change to maximum GNSS resources and demand a change in resource allocation for GNSS track channels. In some scenarios, the all-in-view tracking approach may configure a UE to made bulk decisions or hard-coded decisions like (apply higher elevation mask, remove constellations, or signal types) which have variable performance across regions not arriving at optimized use of resources for performance. Thus, the GNSS positioning performance of the UE may be significantly degraded due to lack of optimization (e.g., tradeoffs include forced performance degradation, or limited concurrence or inability to serve scaled down products with optimal performance).

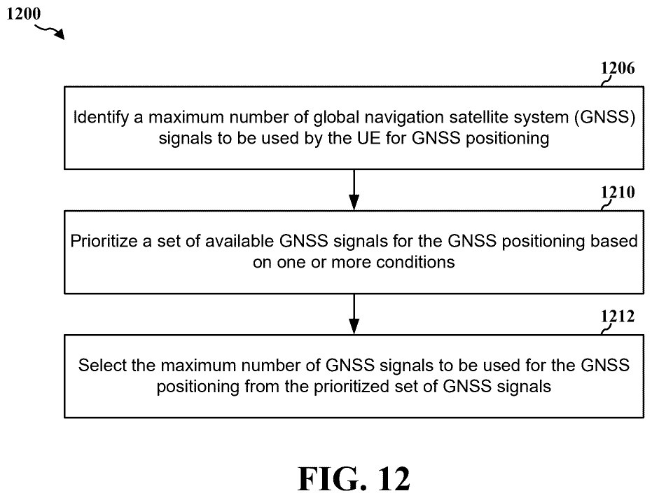

FIG. 12 is a flowchart 1200 of wireless communication. The method may be performed by a user equipment (UE) (e.g., the UE 104, 404, 802; the GNSS device 506; the apparatus 1404). The method may enable a UE to maintain an optimized priority list of GNSS signals/channels to achieve a best GNSS positioning performance with limited resources in real-time.

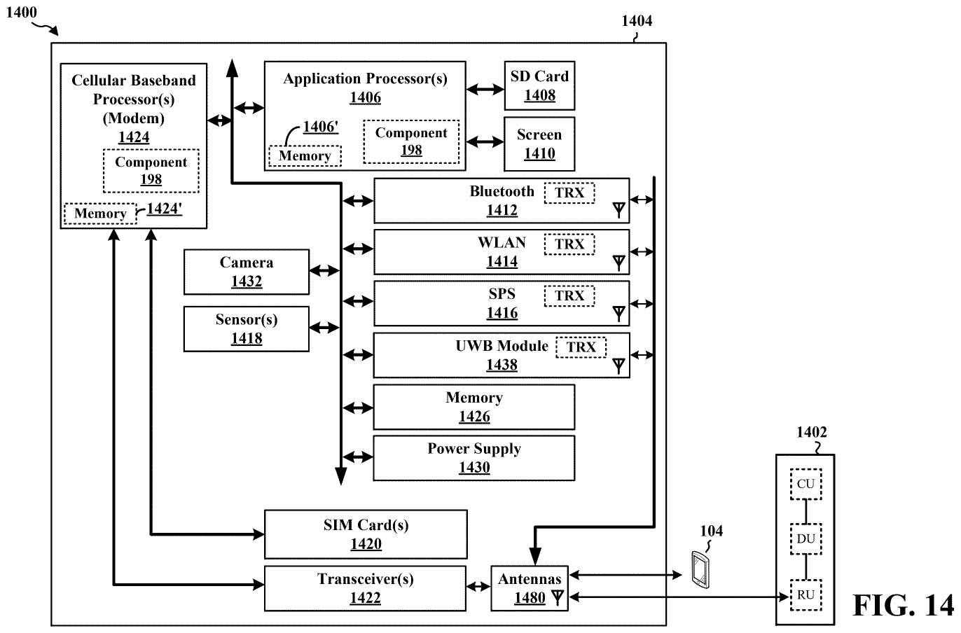

At 1206, the UE may identify a maximum number of GNSS signals to be used by the UE for GNSS positioning, such as described in connection with FIG. 8. For example, at 810, a UE 802 (e.g., a GNSS device, a device with a GNSS receiver, etc.) may be configured to identify a maximum (max) number of GNSS signals (or GNSS channels) that is to be used by the UE 802 for GNSS positioning (or for a GNSS positioning session). The identification of the maximum number of GNSS signals may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In one example, to identify the maximum number of GNSS signals to be used by the UE for the GNSS positioning, the UE may be configured to identify the maximum number of GNSS signals to be used by the UE for the GNSS positioning based on at least one of: whether the UE is used solely for the GNSS positioning, at least one type of RAT used by the UE simultaneously with the GNSS positioning, a location of the UE, an environmental condition of the UE, or a capability of the UE.

In another example, to identify the maximum number of GNSS signals to be used by the UE for the GNSS positioning, the UE may be configured to determine a number of resources that can be used by the UE for processing GNSS signals, and identify the maximum number of GNSS signals based on the number of resources that can be used by the UE for processing GNSS signals. In some implementations, to determine the number of resources that can be used by the UE for processing GNSS signals, the UE may be configured to calculate the number of resources for processing GNSS signals based on at least one of: a current maximum number of resources that can be allocated for the GNSS positioning, a current processing capability or capacity of the UE, a current memory capability or capacity of the UE, a current or a desired throughput of the UE, a current or a desired CPU load of the UE, or a current temperature of one or more components of the UE.

At 1210, the UE may prioritize a set of available GNSS signals for the GNSS positioning based on one or more conditions (e.g., sequentially), such as described in connection with FIG. 8. For example, at 812, the UE 802 may obtain a list of GNSS signals available to the UE 802, and the UE 802 may prioritize this list of available GNSS signals for the GNSS positioning based on applying a plurality of rules/conditions. The prioritization of the set of available GNSS signals may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In one example, to prioritize the set of available GNSS signals for the GNSS positioning based on the one or more conditions, the UE may be configured to order the set of available GNSS signals based on at least one of: (1) visibilities or signal strengths of the set of available GNSS signals, (2) elevation angles of the set of available GNSS signals, (3) types of the set of available GNSS signals, or (4) a set of geographical inputs related to the UE 802. In some implementation, to order the set of available GNSS signals based on at least one of: (1) the visibilities or the signal strengths of the set of available GNSS signals, (2) the elevation angles of the set of available GNSS signals, or (3) the types of the set of available GNSS signals, the UE may be configured to determine a first order of the set of available GNSS signals based on the visibilities or the signal strengths of the set of available GNSS signals, reorder the first order of the set of available GNSS signals based on the elevation angles of the set of available GNSS signals to obtain a second order of the set of available GNSS signals, and reorder the second order of the set of available GNSS signals based on the types of the set of available GNSS signals to obtain a third order of the set of available GNSS signals. In some implementations, to select the maximum number of GNSS signals to be used for the GNSS positioning from the prioritized set of GNSS signals, the UE may be configured to select the maximum number of GNSS signals to be used for the GNSS positioning from the third order of the set of available GNSS signals. In some implementations, the UE may further be configured to reorder the third order of the set of available GNSS signals based on a set of priori variances, a set of observations related to expected position error, a set of geographic selections, or an RF band grouping to obtain a fourth order of the set of available GNSS signals, where to select the maximum number of GNSS signals to be used for the GNSS positioning from the prioritized set of GNSS signals, the UE may be configured to select the maximum number of GNSS signals to be used for the GNSS positioning from the fourth order of the set of available GNSS signals. In some implementations, the ordering or the set of available GNSS signals is further based on at least one of: a constellation precedence, or a policy associated with a country, a region, or a geographical area in which the UE is located.

At 1212, the UE may select the maximum number of GNSS signals to be used for the GNSS positioning from the prioritized set of GNSS signals, such as described in connection with FIG. 8. For example, at 816, after prioritizing the list of available GNSS signals based on applying the plurality of rules/conditions sequentially, the UE 802 may select the maximum number of GNSS signals to be used for the GNSS positioning from the prioritized list of available GNSS signals. The selection of the maximum number of GNSS signals may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In one example, the UE may detect that a number of available GNSS signals exceeds the maximum number of GNSS signals to be used by the UE for the GNSS positioning, where the prioritization of the set of GNSS signals is based on the detection that the number of available GNSS signals exceeds the maximum number of GNSS signals to be used by the UE for the GNSS positioning, such as described in connection with FIG. 8. For example, at 814, the UE 802 may also be configured to detect whether the number of available GNSS signals exceeds the maximum number of GNSS signals that is to be used by the UE 802 for the GNSS positioning (e.g., identified/determined at 810). Then, the UE 802 may perform the prioritization of the list of GNSS signals (or the available GNSS signals) if the number of available GNSS signals exceeds the maximum number of GNSS signals to be used for the GNSS positioning. The detection may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In another example, the UE may receive, from a network entity, the set of available GNSS signals based on a location of the UE, such as described in connection with FIG. 8. For example, the list of GNSS signals available to the UE 802 may be received from a network entity 804 (e.g., a positioning server, a location management function (LMF), a cloud server, a base station/TRP, etc.) such as shown at 820 (e.g., which may be based on an estimated location/geographical area of the UE 802). The reception of the set of available GNSS signals may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In another example, the set of available GNSS signals includes one or more of: a set of GPS signals, a set of BDS signals, a set of GLONASS signals, a set of NavIC signals, or a set of SBAS signals.

In another example, the UE may receive, from a network entity, a least one of: an indication of a set of conditions or an update to the set of conditions, such as described in connection with FIG. 8. For example, at 822, the UE 802 may receive the plurality of rules/conditions, or update(s) to the plurality of rules/conditions, from the network entity 804 from time to time (or periodically), such that the way UE 802 prioritizes the available GNSS signals may be modified or changed (dynamically). The reception of the indication and/or the update may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In another example, the UE may perform the GNSS positioning based on the maximum number of GNSS signals selected from the prioritized number of available GNSS signals, such as described in connection with FIG. 8. For example, at 818, the UE 802 may perform the GNSS positioning based on the maximum number of GNSS signals selected from the prioritized set of available GNSS signals (e.g., based on using the 75 GNSS signals selected from the prioritized list of available GNSS signals shown at 908 of FIG. 11). The GNSS positioning may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14. In some implementations, to perform the GNSS positioning, the UE may be configured to estimate a location of the UE based on measurements of the GNSS signals, and output an indication of the location of the UE. In some implementations, to output the indication of the location of the UE, the UE may be configured to at least one of: transmit the location of the UE, store the location of the UE, or display, via a UI, the location of the UE.

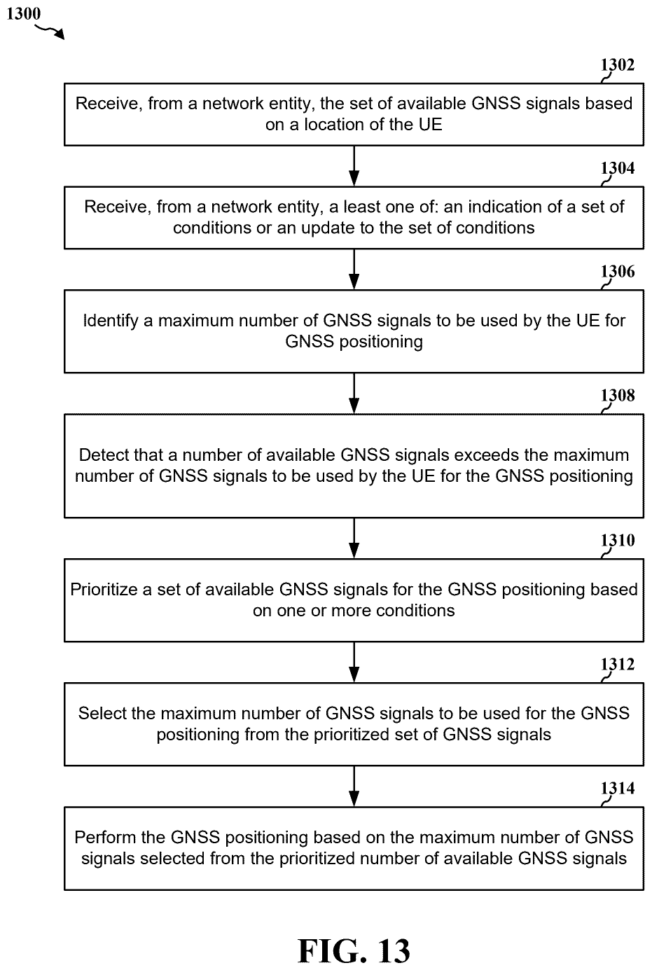

FIG. 13 is a flowchart 1300 of wireless communication. The method may be performed by a user equipment (UE) (e.g., the UE 104, 404, 802; the GNSS device 506; the apparatus 1404). The method may enable a UE to maintain an optimized priority list of GNSS signals/channels to achieve a best GNSS positioning performance with limited resources in real-time.

At 1306, the UE may identify a maximum number of GNSS signals to be used by the UE for GNSS positioning, such as described in connection with FIG. 8. For example, at 810, a UE 802 (e.g., a GNSS device, a device with a GNSS receiver, etc.) may be configured to identify a maximum (max) number of GNSS signals (or GNSS channels) that is to be used by the UE 802 for GNSS positioning (or for a GNSS positioning session). The identification of the maximum number of GNSS signals may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In one example, to identify the maximum number of GNSS signals to be used by the UE for the GNSS positioning, the UE may be configured to identify the maximum number of GNSS signals to be used by the UE for the GNSS positioning based on at least one of: whether the UE is used solely for the GNSS positioning, at least one type of RAT used by the UE simultaneously with the GNSS positioning, a location of the UE, an environmental condition of the UE, or a capability of the UE.

In another example, to identify the maximum number of GNSS signals to be used by the UE for the GNSS positioning, the UE may be configured to determine a number of resources that can be used by the UE for processing GNSS signals, and identify the maximum number of GNSS signals based on the number of resources that can be used by the UE for processing GNSS signals. In some implementations, to determine the number of resources that can be used by the UE for processing GNSS signals, the UE may be configured to calculate the number of resources for processing GNSS signals based on at least one of: a current maximum number of resources that can be allocated for the GNSS positioning, a current processing capability or capacity of the UE, a current memory capability or capacity of the UE, a current or a desired throughput of the UE, a current or a desired CPU load of the UE, or a current temperature of one or more components of the UE.

At 1310, the UE may prioritize a set of available GNSS signals for the GNSS positioning based on one or more conditions, such as described in connection with FIG. 8. For example, at 812, the UE 802 may obtain a list of GNSS signals available to the UE 802, and the UE 802 may prioritize this list of available GNSS signals for the GNSS positioning based on applying a plurality of rules/conditions. The prioritization of the set of available GNSS signals may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In one example, to prioritize the set of available GNSS signals for the GNSS positioning based on the one or more conditions, the UE may be configured to order the set of available GNSS signals based on at least one of: (1) visibilities or signal strengths of the set of available GNSS signals, (2) elevation angles of the set of available GNSS signals, (3) types of the set of available GNSS signals, or (4) a set of geographical inputs related to the UE 802. In some implementation, to order the set of available GNSS signals based on at least one of: (1) the visibilities or the signal strengths of the set of available GNSS signals, (2) the elevation angles of the set of available GNSS signals, or (3) the types of the set of available GNSS signals, the UE may be configured to determine a first order of the set of available GNSS signals based on the visibilities or the signal strengths of the set of available GNSS signals, reorder the first order of the set of available GNSS signals based on the elevation angles of the set of available GNSS signals to obtain a second order of the set of available GNSS signals, and reorder the second order of the set of available GNSS signals based on the types of the set of available GNSS signals to obtain a third order of the set of available GNSS signals. In some implementations, to select the maximum number of GNSS signals to be used for the GNSS positioning from the prioritized set of GNSS signals, the UE may be configured to select the maximum number of GNSS signals to be used for the GNSS positioning from the third order of the set of available GNSS signals. In some implementations, the UE may further be configured to reorder the third order of the set of available GNSS signals based on a set of priori variances, a set of observations related to expected position error, a set of geographic selections, or an RF band grouping to obtain a fourth order of the set of available GNSS signals, where to select the maximum number of GNSS signals to be used for the GNSS positioning from the prioritized set of GNSS signals, the UE may be configured to select the maximum number of GNSS signals to be used for the GNSS positioning from the fourth order of the set of available GNSS signals. In some implementations, the ordering or the set of available GNSS signals is further based on at least one of: a constellation precedence, or a policy associated with a country, a region, or a geographical area in which the UE is located.

At 1312, the UE may select the maximum number of GNSS signals to be used for the GNSS positioning from the prioritized set of GNSS signals, such as described in connection with FIG. 8. For example, at 816, after prioritizing the list of available GNSS signals based on applying the plurality of rules/conditions sequentially, the UE 802 may select the maximum number of GNSS signals to be used for the GNSS positioning from the prioritized list of available GNSS signals. The selection of the maximum number of GNSS signals may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In one example, as shown at 1308, the UE may detect that a number of available GNSS signals exceeds the maximum number of GNSS signals to be used by the UE for the GNSS positioning, where the prioritization of the set of GNSS signals is based on the detection that the number of available GNSS signals exceeds the maximum number of GNSS signals to be used by the UE for the GNSS positioning, such as described in connection with FIG. 8. For example, at 814, the UE 802 may also be configured to detect whether the number of available GNSS signals exceeds the maximum number of GNSS signals that is to be used by the UE 802 for the GNSS positioning (e.g., identified/determined at 810). Then, the UE 802 may perform the prioritization of the list of GNSS signals (or the available GNSS signals) if the number of available GNSS signals exceeds the maximum number of GNSS signals to be used for the GNSS positioning. The detection may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In another example, as shown at 1302, the UE may receive, from a network entity, the set of available GNSS signals based on a location of the UE, such as described in connection with FIG. 8. For example, the list of GNSS signals available to the UE 802 may be received from a network entity 804 (e.g., a positioning server, a location management function (LMF), a cloud server, a base station/TRP, etc.) such as shown at 820 (e.g., which may be based on an estimated location/geographical area of the UE 802). The reception of the set of available GNSS signals may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In another example, the set of available GNSS signals includes one or more of: a set of GPS signals, a set of BDS signals, a set of GLONASS signals, a set of NavIC signals, or a set of SBAS signals.

In another example, as shown at 1304, the UE may receive, from a network entity, a least one of: an indication of a set of conditions or an update to the set of conditions, such as described in connection with FIG. 8. For example, at 822, the UE 802 may receive the plurality of rules/conditions, or update(s) to the plurality of rules/conditions, from the network entity 804 from time to time (or periodically), such that the way UE 802 prioritizes the available GNSS signals may be modified or changed (dynamically). The reception of the indication and/or the update may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14.

In another example, as shown at 1314, the UE may perform the GNSS positioning based on the maximum number of GNSS signals selected from the prioritized number of available GNSS signals, such as described in connection with FIG. 8. For example, at 818, the UE 802 may perform the GNSS positioning based on the maximum number of GNSS signals selected from the prioritized set of available GNSS signals (e.g., based on using the 75 GNSS signals selected from the prioritized list of available GNSS signals shown at 908 of FIG. 11). The GNSS positioning may be performed by, e.g., the GNSS signal prioritization component 198, the transceiver(s) 1422, the SPS module 1416, the cellular baseband processor(s) 1424, and/or the application processor(s) 1406 of the apparatus 1404 in FIG. 14. In some implementations, to perform the GNSS positioning, the UE may be configured to estimate a location of the UE based on measurements of the GNSS signals, and output an indication of the location of the UE. In some implementations, to output the indication of the location of the UE, the UE may be configured to at least one of: transmit the location of the UE, store the location of the UE, or display, via a UI, the location of the UE.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an ultrawide band (UWB) module 1438 (e.g., a UWB transceiver), an SPS module 1416 (e.g., GNSS module), one or more sensors 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the UWB module 1438, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the GNSS signal prioritization component 198 may be configured to identify a maximum number of GNSS signals to be used by the UE for GNSS positioning. The GNSS signal prioritization component 198 may also be configured to prioritize a set of available GNSS signals for the GNSS positioning based on one or more conditions. The GNSS signal prioritization component 198 may also be configured to select the maximum number of GNSS signals to be used for the GNSS positioning from the prioritized set of GNSS signals. The GNSS signal prioritization component 198 may be within the cellular baseband processor(s) 1424, the application processor(s) 1406, or both the cellular baseband processor(s) 1424 and the application processor(s) 1406. The GNSS signal prioritization component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for identifying a maximum number of GNSS signals to be used by the UE for GNSS positioning. The apparatus 1404 may further include means for prioritizing a set of available GNSS signals for the GNSS positioning based on one or more conditions. The apparatus 1404 may further include means for selecting the maximum number of GNSS signals to be used for the GNSS positioning from the prioritized set of GNSS signals.

In one configuration, the means for identifying the maximum number of GNSS signals to be used by the UE for the GNSS positioning may including configuring the apparatus 1404 to identify the maximum number of GNSS signals to be used by the UE for the GNSS positioning based on at least one of: whether the UE is used solely for the GNSS positioning, at least one type of RAT used by the UE simultaneously with the GNSS positioning, a location of the UE, an environmental condition of the UE, or a capability of the UE.

In another configuration, the means for identifying the maximum number of GNSS signals to be used by the UE for the GNSS positioning may including configuring the apparatus 1404 to determine a number of resources that can be used by the UE for processing GNSS signals, and identify the maximum number of GNSS signals based on the number of resources that can be used by the UE for processing GNSS signals. In some implementations, to determine the number of resources that can be used by the UE for processing GNSS signals, the apparatus 1404 may be configured to calculate the number of resources for processing GNSS signals based on at least one of: a current maximum number of resources that can be allocated for the GNSS positioning, a current processing capability or capacity of the UE, a current memory capability or capacity of the UE, a current or a desired throughput of the UE, a current or a desired CPU load of the UE, or a current temperature of one or more components of the UE.

In another configuration, the means for prioritizing the set of available GNSS signals for the GNSS positioning based on the one or more conditions may include configuring the apparatus 1404 to order the set of available GNSS signals based on at least one of: (1) visibilities or signal strengths of the set of available GNSS signals, (2) elevation angles of the set of available GNSS signals, (3) types of the set of available GNSS signals, or (4) a set of geographical inputs related to the UE 802. In some implementation, to order the set of available GNSS signals based on at least one of: (1) the visibilities or the signal strengths of the set of available GNSS signals, (2) the elevation angles of the set of available GNSS signals, or (3) the types of the set of available GNSS signals, the apparatus 1404 may be configured to determine a first order of the set of available GNSS signals based on the visibilities or the signal strengths of the set of available GNSS signals, reorder the first order of the set of available GNSS signals based on the elevation angles of the set of available GNSS signals to obtain a second order of the set of available GNSS signals, and reorder the second order of the set of available GNSS signals based on the types of the set of available GNSS signals to obtain a third order of the set of available GNSS signals. In some implementations, the means for selecting the maximum number of GNSS signals to be used for the GNSS positioning from the prioritized set of GNSS signals may including configuring the apparatus 1404 to select the maximum number of GNSS signals to be used for the GNSS positioning from the third order of the set of available GNSS signals. In some implementations, the apparatus 1404 may further include means for reordering the third order of the set of available GNSS signals based on a set of priori variances, a set of observations related to expected position error, a set of geographic selections, or an RF band grouping to obtain a fourth order of the set of available GNSS signals, where the means for selecting the maximum number of GNSS signals to be used for the GNSS positioning from the prioritized set of GNSS signals may including configuring the apparatus 1404 to select the maximum number of GNSS signals to be used for the GNSS positioning from the fourth order of the set of available GNSS signals. In some implementations, the ordering or the set of available GNSS signals is further based on at least one of: a constellation precedence, or a policy associated with a country, a region, or a geographical area in which the UE is located.

In another configuration, the apparatus 1404 may further include means for detecting that a number of available GNSS signals exceeds the maximum number of GNSS signals to be used by the UE for the GNSS positioning, where the prioritization of the set of GNSS signals is based on the detection that the number of available GNSS signals exceeds the maximum number of GNSS signals to be used by the UE for the GNSS positioning.

In another configuration, the apparatus 1404 may further include means for receiving, from a network entity, the set of available GNSS signals based on a location of the UE.

In another configuration, the set of available GNSS signals includes one or more of: a set of GPS signals, a set of BDS signals, a set of GLONASS signals, a set of NavIC signals, or a set of SBAS signals.

In another configuration, the apparatus 1404 may further include means for receiving, from a network entity, a least one of: an indication of a set of conditions or an update to the set of conditions.

In another configuration, the apparatus 1404 may further include means for performing the GNSS positioning based on the maximum number of GNSS signals selected from the prioritized number of available GNSS signals. In some implementations, the means for performing the GNSS positioning may include configuring the apparatus 1404 to estimate a location of the UE based on measurements of the GNSS signals, and output an indication of the location of the UE. In some implementations, th means for outputting the indication of the location of the UE may including configuring the apparatus 1404 to at least one of: transmit the location of the UE, store the location of the UE, or display, via a UI, the location of the UE.

The means may be the GNSS signal prioritization component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: identifying a maximum number of global navigation satellite system (GNSS) signals to be used by the UE for GNSS positioning; prioritizing a set of available GNSS signals for the GNSS positioning based on one or more conditions; and selecting the maximum number of GNSS signals to be used for the GNSS positioning from the prioritized set of GNSS signals.

Aspect 2 is the method of aspect 1, wherein identifying the maximum number of GNSS signals to be used by the UE for the GNSS positioning comprises: identifying the maximum number of GNSS signals to be used by the UE for the GNSS positioning based on at least one of: whether the UE is used solely for the GNSS positioning, at least one type of radio access technology (RAT) used by the UE simultaneously with the GNSS positioning, a location of the UE, an environmental condition of the UE, or a capability of the UE.

Aspect 3 is the method of aspect 1 or aspect 2, wherein identifying the maximum number of GNSS signals to be used by the UE for the GNSS positioning comprises: determining a number of resources that can be used by the UE for processing GNSS signals; and identifying the maximum number of GNSS signals based on the number of resources that can be used by the UE for processing GNSS signals.

Aspect 4 is the method of any of aspects 1 to 3, wherein determining the number of resources that can be used by the UE for processing GNSS signals comprises: calculating the number of resources for processing GNSS signals based on at least one of: a current maximum number of resources that can be allocated for the GNSS positioning, a current processing capability or capacity of the UE, a current memory capability or capacity of the UE, a current or a desired throughput of the UE, a current or a desired central processing unit (CPU) load of the UE, or a current temperature of one or more components of the UE.

Aspect 5 is the method of any of aspects 1 to 4, further comprising: detecting that a number of available GNSS signals exceeds the maximum number of GNSS signals to be used by the UE for the GNSS positioning, wherein the prioritization of the set of GNSS signals is based on the detection that the number of available GNSS signals exceeds the maximum number of GNSS signals to be used by the UE for the GNSS positioning.

Aspect 6 is the method of any of aspects 1 to 5, wherein prioritizing the set of available GNSS signals for the GNSS positioning based on the one or more conditions comprises: ordering the set of available GNSS signals based on at least one of: (1) visibilities or signal strengths of the set of available GNSS signals, (2) elevation angles of the set of available GNSS signals, or (3) types of the set of available GNSS signals.

Aspect 7 is the method of any of aspects 1 to 6, wherein ordering the set of available GNSS signals based on at least one of: (1) the visibilities or the signal strengths of the set of available GNSS signals, (2) the elevation angles of the set of available GNSS signals, or (3) the types of the set of available GNSS signals comprises: determining a first order of the set of available GNSS signals based on the visibilities or the signal strengths of the set of available GNSS signals; reordering the first order of the set of available GNSS signals based on the elevation angles of the set of available GNSS signals to obtain a second order of the set of available GNSS signals; and reordering the second order of the set of available GNSS signals based on the types of the set of available GNSS signals to obtain a third order of the set of available GNSS signals.

Aspect 8 is the method of any of aspects 1 to 7, wherein selecting the maximum number of GNSS signals to be used for the GNSS positioning from the prioritized set of GNSS signals comprises: selecting the maximum number of GNSS signals to be used for the GNSS positioning from the third order of the set of available GNSS signals.

Aspect 9 is the method of any of aspects 1 to 8, further comprising: reordering the third order of the set of available GNSS signals based on a set of priori variances, a set of observations related to expected position error, a set of geographic selections, or a radio frequency (RF) band grouping to obtain a fourth order of the set of available GNSS signals, wherein selecting the maximum number of GNSS signals to be used for the GNSS positioning from the prioritized set of GNSS signals comprises selecting the maximum number of GNSS signals to be used for the GNSS positioning from the fourth order of the set of available GNSS signals.

Aspect 10 is the method of any of aspects 1 to 9, wherein the ordering or the set of available GNSS signals is further based on at least one of: a constellation precedence, or a policy associated with a country, a region, or a geographical area in which the UE is located.

Aspect 11 is the method of any of aspects 1 to 10, further comprising: receiving, from a network entity, the set of available GNSS signals based on a location of the UE.

Aspect 12 is the method of any of aspects 1 to 11, further comprising: receiving, from a network entity, a least one of: an indication of a set of conditions or an update to the set of conditions.

Aspect 13 is the method of any of aspects 1 to 12, further comprising: performing the GNSS positioning based on the maximum number of GNSS signals selected from the prioritized number of available GNSS signals.

Aspect 14 is the method of any of aspects 1 to 13, wherein performing the GNSS positioning comprises: estimating a location of the UE based on measurements of the GNSS signals, and outputting an indication of the location of the UE.

Aspect 15 is the method of any of aspects 1 to 14, wherein outputting the indication of the location of the UE comprises at least one of: transmitting the location of the UE, storing the location of the UE, or displaying, via a user interface (UI), the location of the UE.

Aspect 16 is the method of any of aspects 1 to 15, wherein the set of available GNSS signals includes one or more of: a set of Global Positioning System (GPS) signals, a set of BeiDou navigation satellite system (BDS) signals, a set of Galileo System signals, a set of Globalnaya Navigatsionnaya Sputnikovaya Sistema (GLONASS) signals, a set of Navigation with Indian Constellation (NavIC) signals, or a set of Satellite Based Augmentation System (SBAS) signals.

Aspect 17 is an apparatus for wireless communication at a user equipment (UE), including: at least one memory; and at least one processor coupled to the at least one memory and, based at least in part on stored information that is stored in the at least one memory, the at least one processor, individually or in any combination, is configured to implement any of aspects 1 to 16.

Aspect 18 is the apparatus of aspect 17, further including at least one transceiver coupled to the at least one processor.

Aspect 19 is an apparatus for wireless communication at a user equipment (UE) including means for implementing any of aspects 1 to 16.

Aspect 20 is a computer-readable medium (e.g., a non-transitory computer-readable medium) storing computer executable code, where the code when executed by a processor causes the processor to implement any of aspects 1 to 16.

What is claimed is:

1. An apparatus for wireless communication at a user equipment (UE), comprising:
at least one memory; and
at least one processor coupled to the at least one memory, the at least one processor, individually or in any combination, is configured to:
identify a maximum number of global navigation satellite system (GNSS) signals to be used by the UE for GNSS positioning;
prioritize a set of available GNSS signals for the GNSS positioning based on one or more conditions; and
select the maximum number of GNSS signals to be used for the GNSS positioning from the prioritized set of GNSS signals.

2. The apparatus of claim 1, wherein to identify the maximum number of GNSS signals to be used by the UE for the GNSS positioning, the at least one processor, individually or in any combination, is configured to:
identify the maximum number of GNSS signals to be used by the UE for the GNSS positioning based on at least one of:
whether the UE is used solely for the GNSS positioning,
at least one type of radio access technology (RAT) used by the UE simultaneously with the GNSS positioning,
a location of the UE,
an environmental condition of the UE, or
a capability of the UE.

3. The apparatus of claim 1, wherein to identify the maximum number of GNSS signals to be used by the UE for the GNSS positioning, the at least one processor, individually or in any combination, is configured to:
determine a number of resources that can be used by the UE for processing GNSS signals; and
identify the maximum number of GNSS signals based on the number of resources that can be used by the UE for processing GNSS signals.

4. The apparatus of claim 3, wherein to determine the number of resources that can be used by the UE for processing GNSS signals, the at least one processor, individually or in any combination, is configured to:
calculate the number of resources for processing GNSS signals based on at least one of:
a current maximum number of resources that can be allocated for the GNSS positioning,
a current processing capability or capacity of the UE,
a current memory capability or capacity of the UE,
a current or a desired throughput of the UE,
a current or a desired central processing unit (CPU) load of the UE, or
a current temperature of one or more components of the UE.

5. The apparatus of claim 1, wherein the at least one processor, individually or in any combination, is further configured to:
detect that a number of available GNSS signals exceeds the maximum number of GNSS signals to be used by the UE for the GNSS positioning, wherein the prioritization of the set of GNSS signals is based on the detection that the number of available GNSS signals exceeds the maximum number of GNSS signals to be used by the UE for the GNSS positioning.

6. The apparatus of claim 1, wherein to prioritize the set of available GNSS signals for the GNSS positioning based on the one or more conditions, the at least one processor, individually or in any combination, is configured to:
order the set of available GNSS signals based on at least one of: (1) visibilities or signal strengths of the set of available GNSS signals, (2) elevation angles of the set of available GNSS signals, (3) types of the set of available GNSS signals, or (4) a set of geographical inputs related to the UE.

7. The apparatus of claim 6, wherein to order the set of available GNSS signals based on at least one of: (1) the visibilities or the signal strengths of the set of available GNSS signals, (2) the elevation angles of the set of available GNSS signals, or (3) the types of the set of available GNSS signals, the at least one processor, individually or in any combination, is configured to:
determine a first order of the set of available GNSS signals based on the visibilities or the signal strengths of the set of available GNSS signals;
reorder the first order of the set of available GNSS signals based on the elevation angles of the set of available GNSS signals to obtain a second order of the set of available GNSS signals; and
reorder the second order of the set of available GNSS signals based on the types of the set of available GNSS signals to obtain a third order of the set of available GNSS signals.

8. The apparatus of claim 7, wherein to select the maximum number of GNSS signals to be used for the GNSS positioning from the prioritized set of GNSS signals, the at least one processor, individually or in any combination, is configured to:
select the maximum number of GNSS signals to be used for the GNSS positioning from the third order of the set of available GNSS signals.

9. The apparatus of claim 7, wherein the at least one processor, individually or in any combination, is further configured to:
reorder the third order of the set of available GNSS signals based on a set of priori variances, a set of observations related to expected position error, a set of geographic selections, or a radio frequency (RF) band grouping to obtain a fourth order of the set of available GNSS signals, wherein to select the maximum number of GNSS signals to be used for the GNSS positioning from the prioritized set of GNSS signals, the at least one processor, individually or in any combination, is configured to select the maximum number of GNSS signals to be used for the GNSS positioning from the fourth order of the set of available GNSS signals.

10. The apparatus of claim 7, wherein the ordering or the set of available GNSS signals is further based on at least one of:
a constellation precedence, or
a policy associated with a country, a region, or a geographical area in which the UE is located.

11. The apparatus of claim 1, wherein the at least one processor, individually or in any combination, is further configured to:
receive, from a network entity via at least one transceiver, the set of available GNSS signals based on a location of the UE.

12. The apparatus of claim 1, wherein the at least one processor, individually or in any combination, is further configured to:
receive, from a network entity via at least one transceiver, a least one of: an indication of a set of conditions or an update to the set of conditions.

13. The apparatus of claim 1, wherein the at least one processor, individually or in any combination, is further configured to:
perform the GNSS positioning based on the maximum number of GNSS signals selected from the prioritized number of available GNSS satellites.

14. The apparatus of claim 13, wherein to perform the GNSS positioning, the at least one processor, individually or in any combination, is further configured to:
estimate a location of the UE based on measurements of the GNSS signals, and
output an indication of the location of the UE.

15. The apparatus of claim 14, wherein to output the indication of the location of the UE, the at least one processor, individually or in any combination, is configured to at least one of:
transmit the location of the UE,
store the location of the UE, or
display, via a user interface (UI), the location of the UE.

16. A method of wireless communication at a user equipment (UE), comprising:
identifying a maximum number of global navigation satellite system (GNSS) signals to be used by the UE for GNSS positioning;
prioritizing a set of available GNSS signals for the GNSS positioning based on one or more conditions; and
selecting the maximum number of GNSS signals to be used for the GNSS positioning from the prioritized set of GNSS signals.

17. The method of claim 16, wherein identifying the maximum number of GNSS signals to be used by the UE for the GNSS positioning comprises:
identifying the maximum number of GNSS signals to be used by the UE for the GNSS positioning based on at least one of:
whether the UE is used solely for the GNSS positioning,
at least one type of radio access technology (RAT) used by the UE simultaneously with the GNSS positioning,
a location of the UE,
an environmental condition of the UE, or
a capability of the UE.

18. The method of claim 16, wherein identifying the maximum number of GNSS signals to be used by the UE for the GNSS positioning comprises:
determining a number of resources that can be used by the UE for processing GNSS signals; and
identifying the maximum number of GNSS signals based on the number of resources that can be used by the UE for processing GNSS signals.

19. The method of claim 16, wherein prioritizing the set of available GNSS signals for the GNSS positioning based on applying the one or more conditions comprises:
ordering the set of available GNSS signals based on at least one of: (1) visibilities or signal strengths of the set of available GNSS signals, (2) elevation angles of the set of available GNSS signals, (3) types of the set of available GNSS signals, or (4) a set of geographical inputs related to the UE.

20. A computer-readable medium storing computer executable code at a user equipment (UE), the code when executed by at least one processor causes the at least one processor to:
identify a maximum number of global navigation satellite system (GNSS) signals to be used by the UE for GNSS positioning;
prioritize a set of available GNSS signals for the GNSS positioning based on one or more conditions; and
select the maximum number of GNSS signals to be used for the GNSS positioning from the prioritized set of GNSS signals.
